(19) United States
(12) Patent Application Publication
(10) Pub. No.: US 2021/0374861 A1
(43) Pub. Date: Dec. 2, 2021

(54) SYSTEM AND METHOD FOR A GLOBAL PEER TO PEER RETIREMENT SAVINGS SYSTEM

(71) Applicant: Dean McClelland, Hong Kong (HK)

(72) Inventor: Dean McClelland, Hong Kong (HK)

(21) Appl. No.: 16/760,543

(22) PCT Filed: Oct. 31, 2018
(86) PCT No.: PCT/IB2018/001371

§ 371 Date: Apr. 30, 2020

Related U.S. Application Data
(60) Provisional application No. 62/579,197, filed on Oct. 31, 2017.

(51) Int. Cl. G06Q 40/06; G06Q 20/22; G06Q 40/04; G06Q 20/02; G06Q 20/10; G06Q 20/40

(52) U.S. Cl. CPC G06Q 40/06; G06Q 20/223; G06Q 40/04; G06Q 20/40145; G06Q 20/108; G06Q 20/227; G06Q 20/02

(57) ABSTRACT

A system and method of operating a peer-to-peer retirement savings system (Tontine System) providing lifetime incomes and longevity insurance in a more efficient manner than traditional systems and which can remain always-fully-funded due to ongoing automatic correction of the input data risk (such as longevity projections, mortality detection, investment return rates, etc) and wherein the system can be trusted more than traditional systems helped by the fact that the characteristics (but not necessarily the identities) of the Tontine System members (Tontine Members) and the underlying asset ledgers and other transaction ledgers (as well as the logic by which executable operations can be triggered) can be made publicly visible in a secured and immutable system so as to allow independent analysts and other interested parties to audit past & projected returns.

### CROSS-REFERENCE TO RELATED APPLICATIONS

This application claims priority to U.S. Provisional Patent Application No. 62/579,197, titled “SYSTEM AND METHOD FOR A GLOBAL PEER TO PEER RETIREMENT SAVINGS SYSTEM” filed on Oct. 31, 2017, and claims priority to Patent Cooperation Treaty (PCT) Application No. PCT/IB2018/001371 filed on Oct. 31, 2018. The specification of the above referenced patent application is incorporated herein by reference in its entirety.

### FIELD OF THE INVENTION

A system and method of operating a peer-to-peer retirement savings system (Tontine System) providing lifetime incomes and longevity insurance in a more efficient manner than traditional systems and which can remain always-fully-funded due to ongoing automatic correction of the input data risk (such as longevity projections, mortality detection, investment return rates, etc) and wherein the system can be trusted more than traditional systems helped by the fact that the characteristics (but not necessarily the identities) of the Tontine System members (Tontine Members) and the underlying asset ledgers and other transaction ledgers (as well as the logic by which executable operations can be triggered) can be made publicly visible in a secured and immutable system so as to allow independent analysts and other interested parties to audit past & projected returns. The system also removes the risk of double counting of assets or hidden liabilities, as each Tontine Member will own a set of entitlement units or tokens biometrically tagged to their pseudonymous identity thereby ensuring that the member's share of underlying payout entitlements is tagged to her or him only for the duration of their entitlement for example the duration of their lifetime. Furthermore, the ownership of the assets of the Tontine System can be effected and/or recorded on a public or private server or block chain a Blockchain or via a clearing house or Blockchain enabled custodian, thus reducing or removing herewith the potential risks including insolvency risk of any otherwise used third parties such as bank, insurer or other centralized counterparty. In fact, the only risk left should be the insolvency risk of the Tontine System itself, which is mitigated completely by adopting a fully automated method to measure, analyse, model, decide and implement corrections based on ever changing and evolving risk data (the “Auto-Actuary”) that auto corrects the Tontine System periodic payouts amounts at any given time going forward. This ensures that the fund (also referred to herein as “the tontine”) of the Tontine System is always solvent for the duration of the payout period(s), be it until there is a last surviving member or until a defined final payout date or other condition is triggered for distribution amongst all surviving members at such final payout date.

### BACKGROUND

Investment plans in general have existed for centuries. According to Wikipedia, one of the oldest known investment plans to raise capital was known as a “Tontine”, pronounced as “tontin.” A tontine is an investment plan for raising capital, devised in the 17th century and relatively widespread in the 18th and 19th centuries. In its original design a tonine combines features of a group annuity and lottery where each subscriber pays a sum or sums into the fund, and thereafter receives a periodical payment for the rest of their life. As subscribers die, their share of the periodical payouts devolve to the other participants, and so the value of each periodical payout increases as the number of surviving subscribers falls. On the death of the last subscriber, the scheme was typically wound up.

Tontines are regulated in Europe under the Directive 2002/83/EC of the European Parliament and are still common in France.

Tontines Life Insurance policies were a major insurance category at the end of the 19^{th} century having been pioneered by Equitable Life Assurance Society until the 1905 Armstrong Investigation in the United States which exposed the practices of US Life Insurers which had engaged in excessive fee charging, misleading marketing based upon false payout projections (justified by using obsolete data and investment return projections) and inappropriate use of customer monies in respect of the underlying investments of the Tontines. Whilst the Armstrong Commission Report did not criticise the tontine principle per se, it led to the introduction of rules restricting the sale of some forms of tontine linked policies. It is notable that the Armstrong Commission Records along with Equitable Life Assurance Society archive's were burned in and 1911 [Source: http//www.americasmutualbanks.com/images/0714_YangPaper.pdf] Nevertheless, in March 2017, The New York Times reported that tontines were attracting fresh consideration as a scheme for people to subscribe to in return for the promise of lifetime retirement incomes. The investment plan is named after Neapolitan banker Lorenzo de Tonti, who is credited with inventing it in France in 1653, although it has been suggested that he merely modified existing European investment schemes. Tonti put his proposal to the French royal government, but after consideration it was rejected by the Parliament de Paris. The first true tontine was therefore organised in the city of Kampen in the Netherlands in 1670.

The key feature was that a relatively fixed payout amount which, for example, could be in the form of dividends or interest, was shared equally among individual members of the Tontine for as long as they lived which meant that in later years as the number of surviving members declined, the payouts per member kept rising, sometimes dramatically.

Since their creation, Tontines have historically proven to be a more appealing source of lifetime income than annuities as recorded by economist Adam Smith in his book “The Wealth of Nations” first published in 1776 in which he stated that “more money can always be raised by tontines than by annuities” and as a result, many variants of Tontines have been used to raise capital or for retirement products or pension plans. A shortcoming of the nature of a Tontine is the existence of a perception that the subscribers, having a financial incentive to do so, might murder each other. In some jurisdictions this perception may have contributed to the creation of practice or legislation that only insurance companies should be authorized to provide any type of mortality-contingent products including Tontines. Retirement investment plans are a recent and natural evolution of the industrial revolution of the last century.

According to Wikipedia, a Canadian “Retirement Savings Plan” (RSP), is a type of Canadian account for holding savings and investment assets. RRSPs have various tax advantages compared to investing outside of tax-preferred accounts. They were introduced in 1957 to promote savings for retirement by employees and self-employed people. In the early 1970s a group of high earning individuals from Kodak approached the US Congress to allow a part of their salary to be invested in the stock market and thus be exempt from income taxes. Section 401(k) was inserted into the Internal Revenue Code making such tax exemptions plans possible and this was enacted into law in 1978. It was intended to allow taxpayers a break on taxes on deferred income. In 1980, a benefits consultant and attorney named Ted Benna took note of the previously obscure provision and figured out that it could be used to create a simple, tax-advantaged way to save for retirement. The client for whom he was working at the time chose not to create a 401(k) plan. He later went on to install the first 401(k) plan at his own employer.

The 21st century has seen the emergence of distributed ledger technologies or “Blockchain” technologies for immutable record-keeping amongst parties that may wish to transact but which may or may not trust each other. In the original paper openly published on May 24, 2009, by Nakamoto and titled “Bitcoin: A Peer-to-Peer Electronic Cash System” (see URL en.bitcoin.it/wiki/Bitcoin_white_paper).Nakamoto described a system where parties could transact with each other by means of pseudonymous accounts recorded on a public distributed ledger where each set of transactions which are appended into tamper proof ledger containing blocks of transactions to form a Blockchain”. We have also seen the increasing emergence of advanced biometric identification technologies which can accurately detect whether biometric data is artificially created or is coming from a living source. These technologies have enabled the creation of systems where users enter into transactions by proving their identity but with the incidental effect that these systems now have the potential to be used to prove the liveness of a particular individual and that a particular individual has not died. Through combining these technologies within a single system, we can create a system where users can create pseudonymous accounts in a system where their transactions and status as well as the transactions and status of other pseudonymous members of the system transactions can be made wholly or partly conditional upon users interacting with the system to provide proof of life when authorising transactions and as such we can design these systems to safely permit mortality-contingent transactions on a peer-to-peer basis thereby mitigating the need for the participation of a central counterparty such as an insurance company which typically comes with high costs which must be borne by members of the system and which on the evidence of the global financial crisis in 2008 can still expose members to the practices which were uncovered during the Armstrong investigation 113 years earlier. Accordingly, we can now use these technologies to create a system where peer-to-peer financial products such as Tontines which can be safely operated without the significant costs and risks which can affect such products when offered by or guaranteed by governments, corporations or life insurers. As such, the Tontine System of this invention is designed around the precise needs of consumers, such that groups of consumers can now safely self-insure the financial risks of increasingly lengthy retirements through pooling their capital into a peer-to-peer longevity risk sharing system which can be constructed to offer members of the system lifetime income products such as Tontines and/or other annuity type products and where such peer-to-peer products can potentially have far lower running costs and as such would be able to offer better outcomes for the consumers than equivalent products traditionally offered by insurance companies.

This invention is part of a Tontine system which can offer the following utility to consumers and pension providers:
a far more cost-efficient solution for the millions of consumers across the planet currently investing an estimated $350Bn+ per annum into annuity type products to secure suitable levels of income in retirement, and
   a new type of commission system which will incentivize networks of financial advisors to take Tontines to the global marketplace without the consumer having to bear the costs of advisor commissions out of their capital contributions rather than deducting sums from the customers capital In essence, the fees and commissions can be wholly or partly settled using a medium of exchange the value of which is represented by its utility value to users including professional users of the Tontine System itself.
An adaptive payout system which is designed to ensure that the system is always-fully-funded and as such eliminates the insolvency risk which affects consumers with entitlements that are or will become due from government, state and corporate pension funds as well as many annuity providers and insurance companies,
User interfaces which can display accurate and realistic projections as to the potential payouts of the fund based upon near real time data thereby ensuring that users can make more informed investment decisions with the underlying projections being recreatable at any point in the future due to the data & statistics being recorded in immutable ledgers.
In the preferred embodiment of the system, in the event of any negative or flat investment years, the system of this invention will, through automated computer protocol or computer programs (for example through automatically executing contracts also known as “Smart Contracts”) automatically adjust payouts in response to new data inputs; an example of which would be where investment returns are higher or lower than expected and the Auto-Actuary of the system would adjust current and future payouts to members until such time in the future that the Auto-Actuary component of the system would determine through it's own calculations that as a result of mortality credits, changes in actual or expected longevity, or changes in actual or expected investment returns or other factors that the system could re-adjust the payout calculations to adjust the current and projected future payout entitlements s of the system to it's valid members.

The security of member assets of the Tontine ecosystem of this invention are ensured through ultimate transparency using Distributed Ledger Technology (DLT), Blockchain (growing list of records or blocks secured by cryptography) & Smart Contracts. The use of distributed ledger technology enables Tontine ecosystem members, and even the public generally, to audit the progress & forecasts of the Tontine of this invention, through exposing
the location, composition and updated, or even, live value of underlying assets,
a record of all investment transactions, fees charged as well as payments made and received
a record of the status of pseudonymous member accounts and of contributions received from and distributions made to each of these,
the projected short, medium and long term payouts that all or each of the pseudonymous members can expect.

The member composition (but not the member identities of the Tontine Members of this invention), transaction history, and the underlying assets of this invention will be made visible. This way analysts and other interested parties including supervisory authorities are able to audit past & projected returns to ensure the highest levels of transparency. The system can make available to parties such as auditors or regulators or others tools with which they themselves can query the status of the system. Such tools may comprise zero knowledge proofs which are protocols designed to evidence aspects of a system, for example, solvency, without revealing sensitive information such as algorithms, risk protocols or confidential data regarding the members. Such transparency guarantees that there can be no risk of double counting of assets or hidden liabilities, as each Tontine Member will own a set of entitlement units or tokens biometrically tagged to their encrypted identity thereby ensuring that the member's share of underlying payout entitlements is tagged to her or him only, for example, as long as the member is able to prove to the system that they are alive.

Furthermore, by securing the ownership of the assets on a distributed ledger, as an example within a Blockchain enabled custodian, the Tontine Members of this invention are protected against the insolvency risk of any third-party bank, insurer or other centralized counterparty. In fact the only risk left would be the insolvency risk of the Tontine System of this invention itself, which is mitigated completely by adopting a fully automated method to measure and decide corrections based on ever changing and evolving risk data (Auto-Actuary) that auto corrects the Tontine System of this invention's payouts at any given time going forward, warrants the solvency of financial composition of Tontine System of this invention for the duration of payout period, be it until the last surviving member or till a defined final payout date for distribution amongst all surviving members at such payout period. The novelty of the Auto-Actuary of this invention will described in further detail in the appropriate sections of this invention as well as in the appropriate Claims section of this invention.

A similar industry term, robo actuary, has been used in the actuary summit 2017 by Deloitte in their article “Man versus machine—the rise of the robo actuary” referring to robotic process automation in general. The Auto-Actuary of this invention in particular removes any political decisions as well as human emotions & biases from the payout calculations, unlike a human actuary which often has to make or ignore politically or emotionally hard or easy decisions, the Auto-Actuary is an independent and autonomous non-human arbiter which merely has, or using machine learning protocols develops, correct processes to follow and execute. The Auto-Actuary of this invention follows a set of rules that are designed, for example, to ensure that the pension fund or Tontine System fund can never go insolvent. These rules can be implemented by a series of Smart Contracts which draw data from independent & authoritative third-party oracles such that the actuarial models remain wedded to reality and not past assumptions. The main function of the Auto-Actuary of this invention is to effectively auto-pilot the Tontine System or for example, pension fund so as to maximize payouts whilst always mathematically ensuring corrections on the payout value per member such that the payouts shall continue for as long as required for the very last remaining members.

A novelty over the prior art of the Auto-Actuary of this invention is that the pension fund or Tontine System fund in which it is integrated into, automatically connects at frequent time intervals (real-time or live, daily, weekly, monthly or longer intervals) to external databases with ever changing data on the following key data but not limited to these;
mortality rates such as for example but not limited to “The Human Mortality Database” (http://www.mortality.org/) with data from the USA and 38 other countries across the globe or in example to the European statistics servers from Eurostat on longevity (http://ec.europa.eu/eurostat/statistics-explained/index.php/Mortality_and_life expectancy statistics) or many others available,
Intentional database on longevity (IDL) per country http://www.supercentenarians.org/Home/Expand_IDL,
national death index (NDI) such as for example but not limited to (https://www.cdc.gov/nchs/ndi/index.htm or https://www.cdc.gov/nchs/nvss/deaths.htm) which holds US death index records and any such other actuary databases in the relevant countries applicable to the members of the pension fund or Tontine System fund of this invention,
death records on a country by country or state by state or region basis, such as for example in the United Kingdom with data available since 1 Jul. 1837, subdivided as three regions as England & Wales online death register: httpi/www.nationalarchives.gov.uk/help-with-your-research/research-guides/birth-marriage-death-england-and-wales/and for Scotland & Ireland online death register: http://www.nationalarchives.gov.uk/help-with-your-research/research-quides/birth-marriage-death-scotland-and-ireland/and at sea or abroad online death register: http://www.nationalarchives.gov.uk/help-with-your-research/research-guides/birth-marriage-death-sea-or-abroad/. With similar longevity and death registers or databases for most countries around the world, such as but not limited to the US: https://www.cdc.gov/nchs/ndi/index.htm, or http://search.ancestry.com/search/db.aspx?dbid=3693
in the absence of direct biometrical interaction over a certain period of time by a member Auto-Actuary may, or may instruct the system to also trigger a further method to auto search for the accessible external databases of death registrations to confirm that specific member is deceased or not in an automatic manner by the Auto-Actuary and consequently re-calculate the next months and future payouts of the remaining members accordingly.
medical breakthrough impact on longevity or life expectancy, such as for example the massive reduction in mortality on war casualties following the discovery of penicillin in 1928. http://valueofinnovation.org/power-of-innovation/. The Auto-actuary will in this embodiment of the present invention use actual factual past events of medical breakthrough's impact or correlations on mortality or longevity reductions to extrapolate similar future breakthroughs fully autonomously to future medical breakthroughs that the Auto-Actuary detects from the external sources (external 3rd party servers) such as, but not limited, to being obtained from reputable global news feeds or trusted oracles and where the AutoActuary connects to systems which enable ensemble machine learning methods providing access to multiple learning algorithms to obtain better predictive performance than could be obtained from any single learning algorithms alone.

A well-known prior art published article by the “University of Pennsylvania Law Review” relates to fair transfer or distribution methods of assets between people of a certain same group, with title “Tontine pensions” as published by “Jonathan B. Forman & Michael J. Sabin” as Tontine Pensions, U. Pa. L. Rev. 755 (2015). http://scholarship.law.upenn.edu/cgi/viewcontent.cgi?article=9471&context=penn_law_review

The following are prior art patents in the same or similar fields of this invention:

U.S. Pat. No. 6,064,969 by Haskins et al. with priority date 1993 and title: Flexible annuity settlement proposal generating system.

U.S. Pat. No. 5,754,980 by Anderson et al. with priority date 1995 and title: Method of providing for a future benefit conditioned on life expectancies of both an insured and a beneficiary.

US20110131149 by Dellinger et al. with Priority date 1998 and title: Method and Apparatus for Providing Retirement Income Benefits.

US20030233301 by Chen et al. (includes Moshe Milevsky) with Priority date 18 Jun. 2002 and title: Optimal asset allocation during retirement in the presence of fixed and variable immediate life annuities (payout annuities).

US20070226123 by Lutnick at al. with priority date 17 Oct. 2005 and title: Products and processes for managing life instruments.

US20120158612 Robertson et al. with priority date 13 May 2005 and title: System and method for providing financial products.

US20070255638 by Chen et al. (includes Moshe Milevsky) with priority date 1 May 2006 and title: System and method for allocating investor wealth to at least one risky asset and life insurance.

US20130097097 by Valentino et al. with priority date 7 Nov. 2006 and title: Methods and systems for managing longevity risk.

US20080281742 by Lyons et al. with priority date 2007 and title: Pension Fund Systems.

US20090192830 by Shemtob et al. with priority date 24 Jan. 2008 and title: Method and system for determining and selecting a longevity benefit payout.

US20140067719 by Peterson et al. with priority date 23 Sep. 2008 and title: Lifetime financial product.

US20140046871 by Silverman et al. with priority date 8 Aug. 2012 and title: Longevity Retirement Protection Fund System and Method.

Silverman et al. describes a “longevity retirement protection fund” with no tontine effects that allows for annuity-like income during the expected life of the investor and which incorporates a degree of longevity risk sharing. However, their method allows investors to withdraw from the arrangement at any time, providing a degree of liquidity but at the same time Silverman et al. creates a shortcoming as this would materially reduce the expected mortality credits due to the fact that any fund member, or their potential beneficiaries, are incentivised to file a withdrawal/redemption notice as soon as they believe that their health is deteriorating. For example, they are diagnosed with a chronic condition. A further shortcoming is that if for whatever reason all but one investor decided to redeem their investments, then the arrangement would have failed to provide any degree of longevity risk sharing to the last remaining investor. Further shortcomings include that under the preferred Silverman embodiment, investors must pass (repeated) health screening tests and are able to decide how their capital should be invested, with this latter embodiment exposing other members of the fund (also referred to herein as the tontine) to risks they may not be comfortable with. A further shortcoming of the Silverman method is that it does not adequately compensate its members for investing alongside members of different ages, different contributions or different genders.

For example, if Adam aged 65 and Bob aged 80 each invest $100,000 on the same day, the monthly death probability of Bob is 4 to 6 times higher than Adam however the payoff to the surviving member, particular in the beginning is exactly equal which is inequitable. Similarly, if investors of different gender or contribution sizes enter, the Silverman method only targets an individual glide path and an adjusted total glide path for redemptions without taking into account a fair and equitable risk sharing methodology. The shortcoming of the design in this respect is that in designing for redemptions, Silverman et al. has failed to provide amethod which allows for an actuarially fair proportional sharing of risk and reward entitlements in the fund (also referred to herein as the tontine).

US20140067722 by Milevsky et al. with priority date 4 Sep. 2012 and title: Optimal portfolio withdrawal during retirement in the presence of longevity risk.

US20140229402 by Caron et al. with priority date 2013 and title: Funding and Distribution of Income Stream Payments for a Period Associated with the Longevity of Participant Individuals.

Caron et al. describes a Tontine arrangement that includes both an accumulation and de-accumulation phase in which payouts provide annuity-like lifetime income. Partial payout smoothing is accommodated via a cushion account in which the investment portfolio is divided into a main account from which distributions are made and a cushion account that can be drawn upon as necessary for as long as it remains above zero. Caron et al. creates a shortcoming in that the cushion account when zero or negative does not mitigate any further financial risk to the main account as this would eliminate the cushion and materially affect the payouts with a potential risk of insolvency of the overall fund.

US20150161734 by Shimpi et al. with priority date 2013 and title: Interactive methods and systems for control of investment data including demographic returns.

The prior art by Shimpi et al. does not describe a Tontine, but rather an investment fund that offers “demographic returns” in addition to investment returns. Evidently, the “demographic returns” come about as the result of surrender charges that apply when investors withdraw money at unscheduled times (including withdrawals by heirs at the time of death). Once of the main shortcomings of Shimpi et al. is that allowed withdrawals create a financial risk and materially affect the payouts with a potential risk of insolvency of the overall fund.

US20090271326 by Finfrock et al. with priority date 23 Apr. 2008 and title: Retirement fund and method for generating increase revenue stream.

WO2015172193, application number PCT/AUG2015/050235, by Knox et al. with priority date 15 May 2014 and title: Computer-implemented methods and management systems for managing membership of a group.

One of the shortcomings of Knox et al. is that there no provision is made for any live updates to members of expected returns. Another major shortcoming of Knox et al., as well as is any such other prior art, is the lack of utilisation of appropriate risk parameters to fairly weight member participations from the outset so as to create equitable risk sharing. Another major shortcoming of Knox et al., as well is any such other prior art, is that the risk for human error or sponsor malpractice is not mitigated. For example, in the case of Knox et al, clients could intentionally or through ignorance utilise incorrect inputs, for example, expected return rates, and/or could subsequently amend entries in databases so as achieve objectives which could conflict with the interests of the majority of members. Furthermore Knox et al., as well is any such other prior art, is that the risk parameters are not all managed when external factors change during the longevity period or till the last surviving member, simply because none of the prior art has all risk parameters automated updates from external sources or any automated artificial intelligence (AI) to correlate external events, in example war outbreak, peace deals, medical breakthroughs, real time external accessed fund composition updates, longevity and payouts automated adjustments based on AI using past correlations extrapolated on future risk parameters.

### BRIEF SUMMARY

The present invention is designed to overcome the shortcomings of the prior art and to provide an automated way of resolving the shortcomings of the prior art specifically for mitigating member fraud as well as the probability of human error by partially or fully automating the interaction between the Tontine System, the Tontine Members, the Auto-Actuary and the data it uses to make decisions by means of an Auto-Actuary (method to measure and fairly recalculate corrections on current and future payouts based on ever changing and evolving internal and external accessed risk data without human interaction) communicating with a plurality of internal and external sources over the internet and updating by itself any required data in real-time or at certain time intervals and in an automated form mathematically avoiding insolvency of the fund (also referred to herein as the tontine) by adapting the periodical payments to members as a result of recalculating the payouts every time any input data to the Auto-Actuary changes.

The Auto-Actuary forming part of a system and method of operating a peer-to-peer retirement savings system (Tontine System) which allows for automatic correction of the longevity risk and wherein the composition (but not the identities) of the peer-to-peer retirement savings system members (Tontine Members) and the underlying assets are made publicly visible through the internet. This removes the risk of double counting of assets or hidden liabilities, as each Tontine Member will own a set of units or tokens biometrically tagged to their encrypted identity thereby ensuring that the member's share of underlying payout entitlements is tagged to her or him only during their lifetime or otherwise as prescribed by the member under the rules of the tontine. To provide the ultimate security, the ownership of the assets of the Tontine System of this invention may be held within accounts recorded on a public block chain Blockchain or through Blockchain enabled remote custodians, thus removing herewith the risk of insolvency through exposure to the balance sheets of any bank, insurer or other centralized counterparty. Further, to resolve the shortcoming seen in the entire prior art in that none provide an automated insolvency risk protection. In one embodiment of the present invention, the Tontine System, through the Auto-Actuary system, mitigates that risk completely by adopting a fully automated method to measure and decide corrections based on ever changing and evolving risk data accessed autonomously from internal and external sources (Auto-Actuary) that auto corrects the Tontine System periodic payouts amounts at any given time going forward. This last method warrants the solvency of the tontines (funds) of Tontine System for the duration of the payout period, be it until the last surviving member or until a defined final payout date for distribution amongst all surviving members at such final payout date.

The invention does not require any human intervention for the normal operation once the Tontine System initiates a tontine (fund) be it in any such known assets, funds, (exchange traded funds), company shares, stock market index funds, currencies, digital assets, cash, Governments Bonds (Bonds) or any combination, as the Auto-Actuary will take all required inputs not only from its starting databases but it will get by itself any more recent data from external sources (401 to 403, 201 to 203) globally by itself though the internet and recalculate any and all outputs such as monthly payouts to the members of the Tontine System fund members and performs automatically simulations to choose one case where the payout is the optimal of all the values that provide liquidity and positive cash flow until the date of the oldest member would be of an age equal to the set parameter at the start of the tontine (for example 120 years old).

The Auto-Actuary method or module that overcomes the shortcomings of the prior art provides an overall robust financial protection against insolvency and against potential human errors as the overall Tontine System would be fully automatic running without any human intervention to keep the tontine running properly and payouts flowing until the expected end date.

The current invention offers through the Auto-Actuary method a further solution to the prior art shortcoming of the necessity of manual interaction by employees or staff from a longevity risk sharing product to gather documentary evidence from heirs on the death of a member which in some cases is never provided as heirs may not even know of the member's pension fund. In a further embodiment of the present invention, the proprietary Auto-Actuary interacts at certain intervals through the internet with a plurality of internal and/or external sources globally to verify if any of the published deceased corresponds with a member of the Tontine System, and if so, request an interaction with the actual member through an electronic application on the member's phone requiring a biometrical feedback (eye scan and/or fingerprint and/or facial recognition and/or any such other ID confirmation method) as proof of life.

In a further embodiment of the present invention, the Auto-Actuary requests, at certain time intervals which may coincide with payout frequency set at the beginning, or as decided by the Auto-Actuary based upon the risk parameters of the Tontine System fund or tontine (for example every 1 or 3 months or so), proof of life by a notification to the member on their Smartphone, tablet or other device or via an application on one of these devices. If no proof of life is provided within a pre-defined time, the notification could repeat until a maximum number of tries (for example 3 tries over a 3 month period) then triggers a specific search at external sources for that specific member identity to confirm or disproof his death. Additionally, the triggering event could send an email and/or call a registered heir's phone number with a pre-recorded digital voice inserting the member's name with a message to inform of a deadline to provide biometrical proof of life through the member's electronic application or otherwise interact with an oracle or other authoritative digital services whether private or civil which have the capability to certify as being dead or alive. Individual members must establish proof of life or otherwise, and based upon the results of any of the above methods, the Auto-Actuary could then decide that the member has died and suspend payments or re-allocate or cancel the validity of the expired members tokens in accordance with the conditions of how the tontine and the Tontine System were established at the outset.

The shortcomings of the prior art have been addressed and resolved by the present invention and resolved by the novelties and different embodiments of the present invention, such as but not limited to, in a different embodiment of the present invention by using a combination of one or more methods or any combination thereof of modules that become operable when embedded into one or more systems or distributed systems or Blockchains activating a peer-to-peer retirement savings system (Tontine System) of this invention, such Tontine System having the ability to access multiple other distributed systems, protocols, oracles and other data sources through the internet.

In another embodiment, the Auto-Actuary becomes operable when embedded into a cloud based or a server-based pension fund system or peer-to-peer retirement savings system (Tontine System) of this invention, such Tontine System having alternatively several redundancy servers in different geographical regions.

In yet another embodiment of the present invention, the Auto-Actuary can interact by itself without human intervention with a plurality of asset exchanges and/or third party data sources accessed through the internet, such as ETF exchanges, Bonds exchanges, Stock exchanges, Currency exchanges and so forth as to automatically change the investment composition of the tontine (fund) depending on the established portfolio asset allocation strategy or to make adjustments following a standardised model such as a risk parity portfolio model or other modem portfolio theory investment model or in response to pre-defined risk criteria (such as but not limited to, valuation drop more than a prefixed %, valuation increase more than a pre-fixed %, if crowd sourced news on the internet is recognised as a natural or manmade catastrophe, nuclear incident or potential war that could adversely affect the valuation or return or expected mortality of one or all parts of a tontine to trigger an automated sale or additional buy if cash available if it is understood to positively affect valuation or return).

In a different embodiment of the present invention, the Auto-Actuary monitors Meta Data from the accounts or virtual wallets and interactions with the Tontine Members, including but not limited to biometrical interactions, to flag potential fraud or irregular or suspicious activities as part of risk management to reduce fraud risks.

In yet a different embodiment, multiple Tontine Systems independently or interacting amongst them could form a global Tontine, wherein the Auto-Actuary fully autonomously connects to a plurality of sources (external databases or information accessed through the internet), through the internet, in each country and manage individual member payouts, for example, based upon the IDL data (international database on longevity) from each of the members region or other such cohort specific data sources. This allows for fairly calculated global pools of different nationalities with different longevity expectations yet with the ability to share degrees of risk between otherwise partially or completely distinct cohorts.

In order not to limit the benefits of this invention, in a different embodiment of this invention when more than one Tontine System tontines (funds) are active at the same time, then the Auto-Actuary may manage all tontines (funds) or it may duplicate itself and have one Auto-Actuary managing one tontine and so forth. An object of this invention is to provide methods and systems for automation of processes normally carried out by whole departments of organisations and reducing costs which increases outcomes (in the form of higher retirement incomes) for members. An object of this invention is to provide methods and systems for reducing the instance of fraud where families or other bad actors fail to report that a person which is the subject of a mortality-contingency within the system is dead and which would adversely affect the entitlements of other members of the system that are still alive. An object of this invention is to provide methods and systems for automation of the actuarial process, for example by enclosing them in smart contracts, and eliminating the risk of human error or bias influencing the outcome of calculations.

An object of this invention is to provide methods and systems for providing complete transparency of ledgers including all holdings, all past transactions and calculations and thereby preventing outright fraud as happened in the case of Bernard L. Madoff Investment Securities LLC, mis-selling based upon false projections as was evidenced by the Armstrong Commission Report or through malfeasance by pension trustees whom should be ensuring the solidity of the system but which have the discretion to selectively manipulate elements of the figures to mask mistakes or certain institutional biases or deficiencies such as underfunding by governments or institutions.

### BRIEF DESCRIPTION OF THE SEVERAL VIEWS OF THE DRAWINGS

FIG. 1 represents a typical top-level block diagram as an embodiment of the present invention system, wherein the Auto-Actuary is an integral part thereof. It shows the inter-relationship between a member of the peer-to-peer retirement savings system (Tontine System) of this invention that subscribes online through an internet enabled application, for example through a Smartphone and the interaction of the Tontine System, in particular the Auto-Actuary with external data sources such as but not limited to external Blockchain Custodians and external data sources (servers, distributed ledgers, oracles) with key data such as but not limited to longevity data, death registers, and any such other data used by the Tontine System with the Auto-Actuary of this invention.

FIG. 2A-2B represent a more detailed example of a different embodiment of the present invention system in the form of a flowchart, wherein the Auto-Actuary is an integral part of a pension fund system or a Tontine System fund (tontine). In this embodiment of the present invention FIG. 2 is more detailed example, but not limited to the different parts of a Tontine System and more in particular of the Auto-Actuary.

### DETAILED DESCRIPTION OF THE INVENTION

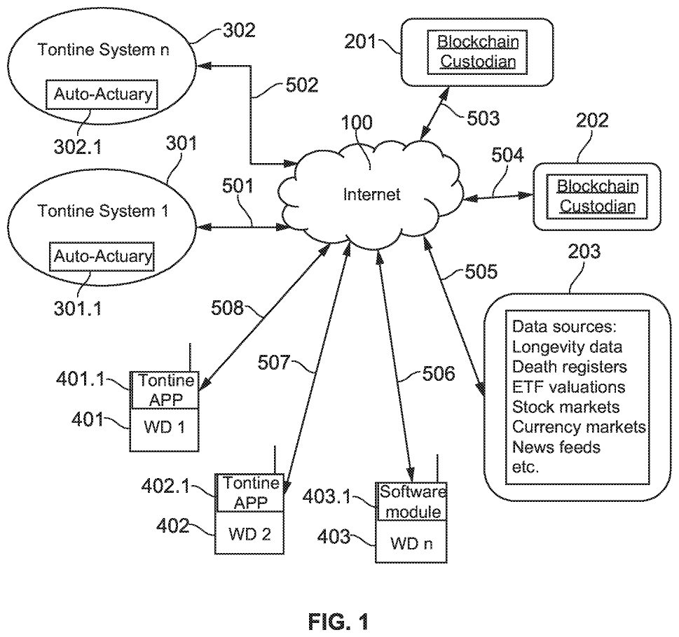

Specifically, FIG. 1 shows a top-level block diagram of an exemplary peer-to-peer retirement savings system (Tontine System) of this invention, where, in this first embodiment, a person that wants to become a member of the (Tontine System) subscribes online through the internet, through his portable computer, mobile phone, Tablet or Smartphone (401, 402, 403). This exemplary Tontine System functions (301, 302) may be duplicated a plurality of times on a plurality of servers distributed ledgers or other processing and storage entities connected to the cloud/internet physically based in the same or different regions around the globe for redundancy and/or immutability reasons or to separate each different Tontine System (301, 302) to isolate specific tontines (funds) or members or to ring fence specific tontine or tontines or to comply with local laws and regulations.

In order to safeguard privacy and transparency amongst other things, the Tontine System (301, 302) of this invention transacts, records and registers its actions and data upon a plurality of Blockchains or independent remote Blockchain Custodians (201, 202), which can be independent services to the Tontine System (301, 302). The Blockchain Custodian (201, 202) is physically duplicated a plurality of times in different servers or other processing and storage entities connected to the cloud/internet, physically based in the same or different regions around the globe for security, redundancy and risk management reasons. In this embodiment, the fully automated method to measure and recalculate and implement corrections on current and future payouts based on ever changing and evolving internal and external accessed risk data without human interaction Auto-Actuary (300.1, 302.1) part of each corresponding Tontine System (301, 302) communicates with external sources (401 to 403, 201 to 203) over the internet in order to regularly update the key parameters it uses to calculate the payouts to the Tontine System members. The main function of the Auto-Actuary (301.1 and/or 302.1) is to ensure, even when there is no human intervention whatsoever, that the corresponding Tontine System (301 or 302) funds are solvent for the duration the Tontine System contracts with its members until the last date of payout or if earlier until the last surviving member(s).

In a different embodiment, the Auto-Actuary (301.1 and/or 302.1) will apart from ensuing the previous, also take into account in the calculation of the payout to each member the data that it obtains fully automated and autonomously from external sources (203), such as but not limited to, update its data on applicable longevity, applicable death registers, corresponding global Currencies, ETFs, Bonds and Stock market valuations, digital asset data, news feeds and so forth.

In a different embodiment of the present invention, the Auto-Actuary (301.1 and/or 302.1) as described above, in essence operates as an Artificial Intelligence (AI) machine, interacting on one hand with external sources to obtain more up-to-date data and re-adjust all its calculations accordingly, and on the other hand interacts with its members for the same reason, namely to update members data and risk parameters and to re-adjust all its calculations accordingly as well as to inform the members of its accounts and payout updates. Furthermore, the AI functions can perform fully autonomously without any human intervention by any employee or representative of the Tontine System (301 and/or 302). In this embodiment, updating and correcting the actual death registers in the Tontine System is done by accessing through the internet external national or regional databases or death registers or other authoritative digital services whether private or civil which have the capability to certify as being dead or alive individual users in the Tontine System (203). This automated function can have safeguards as to double verify with any biometrical interaction the member has done through the electronic application (401.1, 402.1, 403.1) as well as in an automated non-human manner contact a specific member and/or its assigned contact person(s) in the event a death register confirms a same name, sex, nationality and birthdates or a majority of those. The Auto-Actuary (301.1 and/or 302.1) would send a notification to the specific member (401 or 402 or 403) requesting a biometrical identification. This can be done through the electronic application (401.1 or 402.1 or 403.1), sending an email to that specific member and/or his provided contacts, or the Auto-Actuary (301.1 or 302.1) makes ancan make an internet PSTN/Mobile call to that specific member's phone number and/or his provided contact's phone number with a digital pre-set recording requesting biometrical identification as proof of life for his Tontine System account.

In yet another different embodiment, the Auto-Actuary (301.1 and/or 302.1) obtains autonomously the data of all the relevant investments that make up each Tontine System pool, such as ETFs (exchange traded funds), company shares, stock market index, currency trades, real estate investments, governments Bonds trades, digital assets, etc. and makes autonomous decisions as to the composition of the Tontine System investment portfolio (also referred to herein as fund or as tontine or as the tontine) and the currency exposure of each portion of the tontine at any given time, still with the two preset conditions as mentioned previously, namely mathematically ensuring solvency of the Tontine System fund and maximizing the payout to members provided the previous condition is not affected. Also, the Auto-Actuary (301.1 and/or 302.1) optionally may analyze, in a fully autonomous basis, key words from different global news feeds (203) and take decisions in conjunction with all the other data it already accesses, as stated previously. The Auto-Actuary then makes autonomous decisions to change the life expectancies and other risk parameters or to the composition of the Tontine System investment portfolio, or a part thereof. It may also convert all or part to cash into one or several different countries depending on a sentiment analysis of the key words' recurrence, gravity and potential expected impact on the valuation of the Tontine System investment portfolio, be it positive expected impact or negative expected impact.

For completeness, the communication channels (501 to 508) between each part of FIG. 1 (201 to 203, 301 to 302, 401 to 403) to and from the cloud or internet can be done over any existing and future technology, or can be through a fixed line or wireless or cellular or satellite technology.

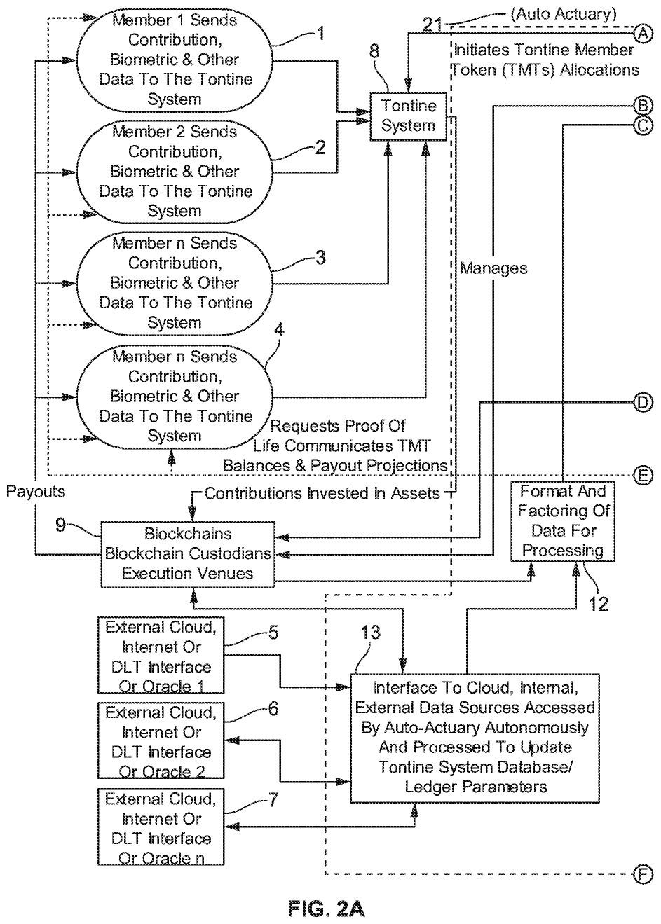

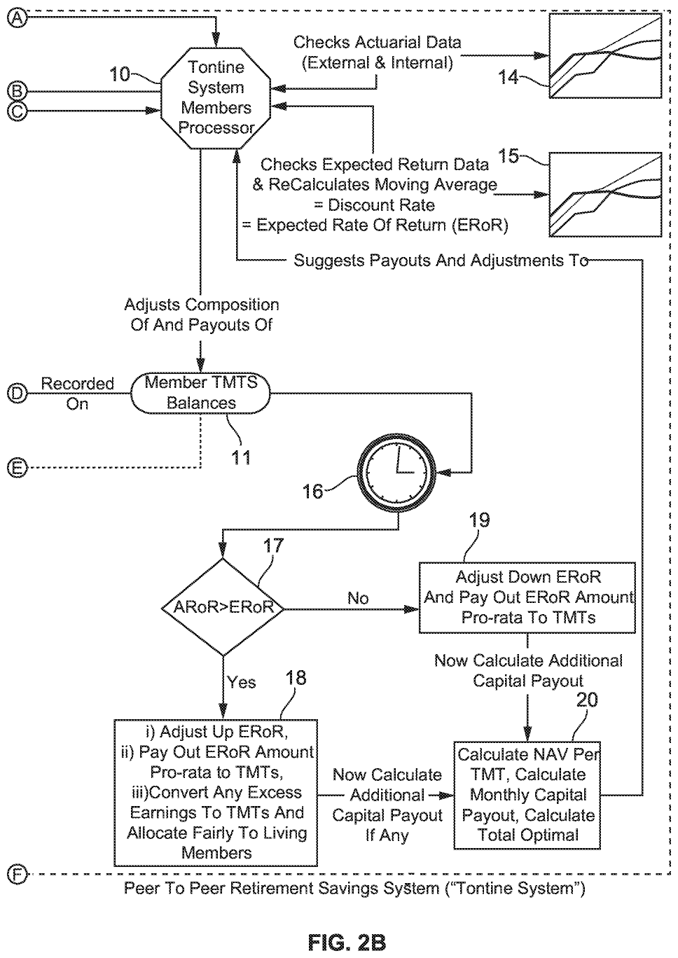

As to FIG. 2A-2B, a different example of an embodiment of the present invention is shown in the form of a flowchart of the “peer-to-peer retirement savings system (Tontine System) is shown wherein the Auto-Actuary of this invention forms an integral part thereof. In a first step, potential future members of the Tontine System (1 to 4) subscribe after downloading the Tontine System electronic application in their personal device (Smartphone, tablet or similar wireless device) or simply subscribe through a portable computer interacting with the Tontine Account (8). As biometrical data is required as part of the Tontine System member account creation and/or maintenance, the electronic application has access to biometrical functionality using, for example, the existing hardware of the wireless devices, such as eye scan, bone scan, voice recognition, vein scan, finger print scan or any such other current or future available unique user identifying biometrical methods. As for those users interacting through a portable computer or similar device or older Smartphone(s) or tablets, the Tontine System interaction will detect those devices without the required biometrical functionality and may offer an alternative means to fulfil the requirement minimum biometrical scanning functions from a 3^{rd} party which the user can access and from which the Tontine System will accept data inputs. There is no human interaction required on the part of the Tontine System itself. Then a user account creation process is completed, for example, by providing the following minimum information: full name, birth date and place, nationality, biometrical identity confirmation and optionally in some or all cases also member's email contact and/or member's fixed and/or mobile telephone number, member's contact person(s) email and phone numbers and/or risk parameters and/or preferred configuration for tontine membership. Finally, or as a prior step, to activate his tontine account, the member has to agree to transfer value, or transfer value in a manner prescribed by the system or enter her or his funds transfer confirmation data (such as transfer code or subject content and/or originating account, etc.). In the event that the contribution the member is transferring money, it may be of any national currency (US$, HK$, Chinese Yuan/Reminbi, £ sterling, Euro, etc.) or any digital asset or virtual currency (Bitcoin, Ethereum, TON.Money etc.) or Real Estate ownership transfer into the tontine or other contribution methods acceptable to the Tontine System from time to time.

All the Tontine System members (1 to 4) account creation details (and ongoing proof of life verifications) as well as the starting tontine portfolio composition of the Tontine System (8) fund are then passed internally to the Auto-Actuary (21) for further processing and at the same time those same data are recorded on the relevant distributed ledger and/or at a plurality of Blockchain based Custodians (9) for safekeeping and for public access. The Auto-Actuary of the present invention will make adjustments to the tontine investment portfolio. The Blockchain Custodian (9) interacts performance data with the Auto-Actuary (21), specifically to block (12) where the Auto-Actuary may adjust the composition of the portfolio further and may monitor the performance data from all sources to calculate an Actual Rate of Return (ARoR) and other relevant data.

In a next step, the Tontine System Members Processor (10) performs a plurality of statistical analyses including for example, comparing the expected return and moving averages of the Expected Rate of Return (ERoR) showing the results accessible in numbers or in graphical figures (15) as well as compares external data from (9 and 13) with internal data from (10) and updates the internal data used by (10) and accessible in numbers or in graphical figures (14). The resulting output of (10), such as but not limited to the translation into the Tontine System digital currency or units of account of entitlements or tokens of this invention called Tontine Member Tokens (TMTs). Such TMT Balance (11) details on a member per member basis are accessible through their corresponding accounts and show in a numeric and graphical format as a number of TMTs and the projected future payouts from which may also be displayed in a currency selected by the member (for example, US Dollar, HK Dollar, Pounds Sterling, Euro, Renminbi, Bitcoin, Etherium, etc.). It should be noted that members which are reasonably technical could utilise their pseudonymous Blockchain addresses corresponding to their TMT member account to review this data directly on the Blockchains themselves without reference to the Tontine System electronic application. Once the composition of the TMT Balances (11) of the members change, such changes are automatically effected directly on the Blockchain, and, where appropriate, any TMT redemption payouts will be co-signed by the Blockchain Custodian (9) and transmitted to Members 1-n (1,2,3,4). The balances of the TMTs (11) can be modified by (10) considering a feedback correction method (20) performed by a combination of the following blocks (17 to 20). At certain predefined time (16) intervals (real-time, daily, weekly, monthly or any other time spans), the auto-feedback correction method performed by blocks (16 to 20) can provoke also a change by (10) in the number and value of TMT Balances (11) and their corresponding currencies.

In a different embodiment of the present invention, at certain time-intervals (16) the Auto-Actuary auto triggers a mathematical analysis and recalculation of all parameters, numbers, and values if the Actual Rate of Return (ARoR) is bigger than x % of Expected Rate of Return (ERoR). Wherein x is a percentage of ERoR as an allowed margin of fluctuation to be added or subtracted to the ERoR value, thus allowing for a certain variation (for example if x=between +3 and −3% or for example a portfolio risk indicator such as the standard deviation) or none at all (if x=0%). In this embodiment of the present invention, x represents a permitted volatility on the expected returns (ERoR), wherein the Auto-Actuary optionally can auto obtain market volatility indexes, applicable to parts or all of the parts of the Tontine System fund composition of this invention. The Auto-Actuary is inter-related into all of these systems. Such volatility indexes could be, but are not limited to the CBEO's volatility index also known by its ticker VIX, as a measure of the volatility index of the S&P500. For example, if x is +−4% and ARoR is 4.9%, then the actual return and expected return ERoR is 5%; then the two values of ERoR to use to check (block 17 of FIG. 2) if ARoR is bigger or smaller than ERoR are between 5%+4% of 5%=5.2% and 5%-4% of 5%=4.8% is “ARoR 4.9%<ERoR 5.2% and ARoR 4.8%<ERoR 4.8%” ?=NOT TRUE

Meaning in this example, there is no action taken to adjust the ERoR. However, if x were to be 0% then no volatility, variation or tolerance would be allowed between expected and actual returns; meaning unless ARoR=ERoR then a corrective action would always be taken, which is the most unlikely scenario as this would allow for zero tolerance between the actual achieved investment returns versus expected returns. So, if (17) determines that ARoR>ERoR there would be a positive adjustment made through (18) of the monthly payouts recalculated going forward through (20) and updating the user accounts (11). However, more importantly in this scenario is that (18) will also recalculate and update the new ERoR and replace the old ERoR everywhere in the Tontine System, and, in particular, in the Auto-Actuary 21. The condition for ARoR>ERoR to be true is based on this condition “If ((ARoR>ERoR+(x % of ERoR)) and (ARoR>ERoR−(x % of ERoR)))=TRUE. However, if (17) determines that ARoR<ERoR there would be negative adjustment made through (19) of the monthly payout recalculated going forward through (20) and communicated to (10), but more importantly in this last scenario is that (19) will also recalculate and update the new ERoR and replace the old ERoR everywhere in the Tontine System. In particular, in the Auto-Actuary 21 and in (10) things would be updated. The condition for ARoR<ERoR to be true is based on this condition “If ((ARoR<ERoR+(x % of ERoR)) and (ARoR<ERoR−(x % of ERoR)))=TRUE.

In a different embodiment of the present invention, the new ERoR calculated by (18 or 19) will be time stamped, as to know which is the newest most recent new ERoR, and send directly to the Custodian (9) or through the Members TMTs account (11) to the blockchain Custodian (9).

In a different embodiment of the present invention, the Auto-Actuary (21) accesses autonomously all the required data from external sources, meaning without the intervention of any staff, employee, or any such other person related to the peer-to-peer retirement savings or pension system Tontine System in which the Auto-Actuary (21) forms an integral part of. In one, but not all embodiments, the only persons with which the Auto-Actuary interacts are the actual members upon which the mortality-contingent conditions are applicable (1 to 4) of the Tontine System to request regular time interval biometrical identification as proof of life or the reverse. The actual members (1 to 4) of the Tontine System access their personal accounts to enter the biometrical identification or to view the status and balances of TMTs and currencies and current and forward payouts. For the avoidance of doubt, the Tontine System, and in particular, the Auto-Actuary (21) of this invention does not require any human intervention nor interaction at all. This makes the system safe from the actual members themselves of the Tontine System of which the Auto-Actuary (21) is integrated into. A key aspect of the present embodiment is that the Auto-Actuary (21) has a method and interfaces (13) to analyze, filter, calculate and take decisions based on data it autonomously obtains through internet interfaces with external sources (5 to 7). Such external sources (5 to 7) that the system accesses are government and private databases and news feeds. In particular, it accesses the relevant longevity databases globally applicable to the Tontine System members as well as the relevant death registers globally applicable to the Tontine System members and optionally to the following:
relevant ETFs markets applicable to the Tontine System composition
relevant Governments Bonds markets applicable to the Tontine System composition
relevant Stocks markets applicable to the Tontine System composition
relevant Currency markets applicable to the Tontine System composition
relevant digital asset markets applicable to the Tontine System composition
global News feeds in general (auto analyze key words on financials, potential starts or endings of wars in regions, break through medical inventions estimated impact on longevity, etc,)
specific News feeds relevant to the Tontine System members, nationality or country of residence or health or age composition
etc.

While values of ETFs or Bonds or Stocks or Currency or death registries are very specific tangible data, all the other data mentioned that the Auto-Actuary (13) can access is in fact Meta Data (data or information that can provide information on other data).

In a different optional embodiment of the present invention, the Meta Data obtained though (13) can be used in conjunction with predictive algorithms to more accurately predict the short and/or long-term effects on the key parameters used by the Auto-Actuary (21). As an example, but not limited to the following examples, when combining recurring messages or words found by (13) from external sources (5 to 7) on a medical breakthrough that is reported by reliable sources to extend longevity of the age group of the Tontine System members by a certain %, say for example 20% longevity increase, would trigger (13) an automatic change in replacing an old longevity parameter upwards by the new longevity parameter through (12) and force a recalculation in (10) of the new ERoR, TMTs weightings and expected payout values stored consequently in (11). All those changes by (13) and in (11) will then be sent automatically to the blockchain Custodian (9).

Another example of this embodiment could be when the algorithms in (13) detect recurring words that could predict up and coming deflation or inflation or war or peace or a disease outbreak in regions that affect the Tontine System fund composition or valuation. Then the Auto-Actuary would autonomously take proportionate decisions to change the composition of the tontine, in one extreme case, to convert the whole fund to cash in a safe haven currency, and in the other events proportionally rebalance the tontine portfolio according to the expected impact in each of the Tontine System fund portfolio parts.

In the past, attempts were made to create systems for managing longevity pools and for redistributing forfeited assets of members which have died, or as they are sometimes known, mortality credits. Those past attempts have become extremely complex and difficult to understand, manage or explain by virtue of the fact that they utilise such idiosyncratic terms (terms that mean one thing to one person and a different thing to another) such as survivor credits, member accounts as distinct from bonuses or bonus accounts, cushion accounts which are provided as a side fund allocated within investment funds, surplus accounts, etc. In 2009, pseudonymous inventor of Bitcoin created a digital peer to peer currency. In fact, the currency is simply an entry in a digital ledger which is distributed across many nodes and which is added to after each subsequent round of validated transactions into a Blockchain. These entries in the ledger represent digital stores of value or tokens. One of the key innovations of Blockchain technology is that payment is the receipt, I.e. no payment has happened until it is confirmed. Once the payment is confirmed, the record of the payment on the Blockchain acts as the receipt. Accordingly, in one embodiment of the present invention, by using tokens on a Blockchain, we now have a simple, immutable means to record ownership of certain entitlements (which may themselves represent value as a medium of exchange) where the entitlements can be programmatically transferred directly between members using smart contracts. While a token may be referred to herein for the purpose of convenience and illustration, it should be noted that the present invention is not limited to use tokens or other digital representations but could also utilise fund participations, fund units, bonds, notes, shares or any other units of account which implementations would still fall within the scope of the invention.

In yet another different embodiment, the Auto-Actuary is responsible for managing the Tontine System which comprises a rules engine in one or more internal and/or external databases or a Smart Contract or series of Smart Contracts in a database or a distributed ledger (for example in a Blockchain) or a combination of both. This includes, or is capable of monitoring data inputs from external sources such as application programming interfaces (APIs) or oracles or any other information source. An oracle is the term for an agent that finds and verifies real-world occurrences and submits this information to a Blockchain to be used by Smart Contracts. These may trigger events if certain pre-defined conditions are met. When a particular value or condition is reached, the Smart Contract changes its state and executes the programmatically predefined algorithms, automatically triggering an event on the Blockchain. The primary task of oracles is to provide these values to the Smart Contract in a secure and trusted manner. Oracles as used within the scope of this invention's embodiment can provide data such as records of successful payments, asset price values or fluctuations, sentiment analysis of external topics, statistical data, civil records, biometric confirmations and so forth.

In a different embodiment of the present invention, the Auto-Actuary upon receiving information from an oracle indicating that a specific member has died, automatically triggers an expiration of that specific members participation in the tontine and then triggers a re-distribution of, or cancellation of, his funds, entitlements or TMT tokens to the remaining members.

The Auto-Actuary of the present invention may also incorporate elements of or become totally reliant upon machine learning which is an application of artificial intelligence (“AI”). This provides systems with the ability to automatically learn and improve from simulations or experience without being explicitly programmed. Machine learning focuses on the development of computer programs that can access data and use it learn for themselves.

The Auto-Actuary of the present invention could have hard coded objectives with orders of priority in regards to fulfilling certain objectives on behalf of the members, examples of which could be but not limited to:
always ensuring the Tontine System is fully funded or solvent during the term,
ensuring that members are treated equitably from day 1 by utilising methodologies for fair distribution of regular payouts and fair re-distribution of tokens from a deceased member to the surviving member. There are several prior art fair distribution systems, such as the “Fair Transfer-plan” as published by Jonathan B. Forman & Michael J. Sabin Tontine Pensions, 163 U. Pa. L. Rev. 755 (2015) or any other equitable methodology which it can learn or be taught,
achieving certain glide-paths or curve with regards to payouts including determining when they should commence for some or all members or targeting a particular level of investment return and/or targeting a particular level of volatility and/or targeting a particular level of income and/or targeting a particular level of risk.

An alternate exemplary system (“System”) includes the following processes/steps:

Creating Account & Authenticating User

Step 1. A user (“User”) accesses System via a website, application or mobile application.
Step 2. System is configured to enable User to initiate the creation of an account using a unique ID (username, phone number, email address, passport number, and SSN etc) wherein System then creates a system account for User utilising a pseudonymous identifier such as an account number or a public key on a blockchain (the “UserID”).
Step 3. System may be configured to enable User to create a biometric signature or password by specifically receiving one or more biometric samples which in every case are analysed for liveness and which therefore can only be used during the course of User's life. Here, System is configured to create a three dimensional map (a “facemap”) of User's face and head, by receiving images and other data of User, taken in real time by the camera and other sensors on User's device from various angles, such that the facemap is so detailed and has so many unique points of reference that it can be expected to even distinguish between User and an identical twin, if any, whilst at the same time performing liveness detection to ensure that the biometric information is being provided from a live person. This set of data points or “facemap” from the live person is then filed in a ledger of System and a cryptographic hash of the facemap file is then generated. The cryptographic hash of the facemap file is saved to the ledgers of System in connection with the UserID.

With the facemap associated with the UserID saved, System may be configured to subsequently retrieve and compare the original facemap to future facemaps presented to the system and determine if User passes the liveness detection challenge and is a member of the system, ensuring that only living Users that are members of the system can validate transactions generating entitlements such as periodical payments to which they may be entitled while they are alive.

System may also be further configured to invite User to create one or more secondary passwords or factors, such as a PIN number, a fingerprint, a retina, and so forth, to enable two factor authentications (“2FA”). The 2FA process is common practice in secure systems to reduce the incidence of unauthorised access to accounts where the user's primary password has been compromised and in the case of the system where, for example, the user's biometric password, e.g. the users face, is being presented to System without the user's knowledge and/or consent.

In a similar embodiment, the abovementioned steps can be in either order or even omitted. For instance, an exemplary embodiment may be configured to approve a valid system login by authenticating the UserID and the associated biometric password, such as a facial password or facemap. This embodiment may be further configured to always perform the 2FA process, like System, or only when the UserID and the primary password (the biometric password) appear to be compromised, such as when a new device is used.

In an alternate embodiment, the biometric password is also the UserID, and the embodiment is configured to accept the input of the biometric password (e.g., the facemap) and subsequently queries the ledgers to match the facemap to an existing facemap within the system embodiment. Another embodiment may or may not be configured to further require to 2FA information.

Step 4. When User attempts to access System, it is configured to approve or disapprove User's login based on the aforementioned methods. For each successful login by User, System can be configured to further save the most recent facemap (and/or other biometric data) and to associate this data in the system and to append its crypotographic hash, to User's associated profile on the ledgers of the system. This way, System may compare future facemaps to a range of facemaps, not just the original facemap when the account was first opened, and thus reduce the incidence of failed matches due to lengthy gaps between which User has not accessed System, during which time the facial characteristics may have evolved significantly due to ageing or changes in User's health or other factors.

User Profile Management

At the time User opens the account, and preferably periodically afterwards, System may be configured to further request, or detect, from User or other sources additional identifying data or characteristics to record on the ledger regarding User. The additional identifying data/characteristics can be useful for System to identify User in the future and/or further refine the risk score of User, such as but not limited to age, gender, ethnicity, socio-economic status, relationship status, health status, residential address, work address, or identity numbers etc.

System is preferably configured to provide User with options for deposit/investment in order to facilitate User to fund his/her account over time or all at once whether by User or by other parties, such as employers, governments, family members, and so forth, via deposit mechanisms that ensure that the deposit can be tracked over the ledger and associated with the pseudonymous UserID of User without revealing the total balance of User's account or which pool or pools User has joined. For example, where transactions are tracked on a public ledger the transactions may be sub divided or mixed but run through a process which can prove that the deposit went to the right place using zero knowledge proofs.

If alternative investment strategies are made available through the System, the System may present comparison data enabling the User to create or select a preferred strategy, among all or suggested strategies by System, based upon User's desired outcomes or best practice.

System is configured to present to User a projected (for example monthly) payout schedule based upon certain risk factors (“RF”), and allow User to set user interface preferences (e.g. currency or language) & conditions: Risk factors may include but are not limited to:
Gender (i.e. Male or Female)
Age (in months)
Contribution Amount (s)(To consider the contribution amounts versus other members of the pool)
   Underlying Investment Strategy selected (Each pool should may have a single investment strategy or a user defined strategy or a user selected strategy from a list of approvable investment strategies)
   Age at which payouts commence (User presented with options based upon starting payouts at for example ages 65, 70 or 75). Note, the algorithm underlying deferred payments must be actuarially fair. I.e. user benefits from compounded growth, mortality credits (MCs) from non-survivors but also an increased weighting in respect of receiving MCs because of the risk of deferral incurred),
   Preferred contribution profile, for example but not limited to, lump sum, monthly payments etc.

Exemplary Method for Determining Projected Payout

Step 1. When a new member seeks to join a pool, System is configured to look at the profile of cohorts in an existing pool and score the new member's probability of death for each potential month (MPoD) between current month and month 1,440 (a potential soft system limit equivalent to 120 years old) and then compares this to the latest MPoDs of existing members of the pool.

Step 2. System is configured to calculate the Annuity Factor model of the aforementioned prior art but in substitution of a discount factor (assumed fixed annual % portfolio return) could utilise a 120 month moving average return of the underlying investment strategy or strategies of the pool.

Step 3. System is configured to calculate the appropriate pro-rata weighting for the new member within the pool based upon the applicable annuity factors and the relative contribution amount and any other appropriate weighting criteria subsequently developed.

Step 4. System is configured to check if new member would acquire more than an acceptable % of the pool, for example 25%, and if so can look to split the investment between other pools or alternatively limits the amount of the initial investment and holds the balance for the benefit of the User to be invested later or returned to the User.

Step 5. Once the appropriate calculations have been made, System is configured to offer the member details of the projections and the conditions of entry and the opportunity to join the system and will provide the instructions for the deposit mechanisms.

Step 6. If the member chooses to join and completes the deposit, System is configured to allocate to the member his/her entitlement units specific to that pool (Tontine Member Units/“TMU”s or TMTs) and the proceeds received we will be recorded on the ledgers and the investment module of the system will invest the proceeds in accordance with the investment strategy or strategies of that pool via the custodian or other investment mechanism.

Note: These units in this exemplary embodiment may have no individual net asset value per se, they are used to calculate an actuarially fair ongoing pro-rata entitlement to a share of payouts from the pool. This is a function of that fact that where the effect of the new member joining affects the overall weighting of the pool this could necessitate additional TMUs being allocated to more than one or all other members in order to properly reweight the whole pool in a mathematically or actuarially fair and precise manner.

Step 7. Before the rollover of the payout period (e.g. month), System is configured to initiate services which notify the members that they need to provide proof-of-life, but which preferably simultaneously check external services for indications that a member has passed away during the course of the month according to the current system configuration. Typically, this will result in each member (“Member”) receiving one or more mobile phone notifications to login using one or more of System's biometric interfaces, such as its three-dimensional facial recognition module, to validate his/her claim to a monthly payout as follows:
a. Member access the device and provides the relevant UserID if not already saved.
b. System is configured to accept the biometric data (e.g. facemap here), via its biometric user interface(s), whilst validating that the data is coming in real time from a live being and compares such validated data to the biometric data stored on the ledger in relation to Member's UserID.
   i. If the facemap matches, then System is configured to request Member to provide his/her PIN or other 2FA, if any is activated. If this is approved, then System is configured to notify Member that his/her claim is accepted and record the claim on the ledger as being a valid claim for this period.
   ii. If Member fails to validate the claim, then Member or System may initiate a process to revalidate the claim of Member. For example, System may be configured to allow Member to try again, but in the event that no valid claim is submitted within the period, no claim for that period is recorded in the ledger and System or Member may initiate a service which seeks to examine the case in more detail via a claim escalation module.

To the extent that Member's account is deactivated and subsequently re-activated and becomes entitled to backdated claims, System is configured to make at the earliest opportunity with the back payments treated as an exceptional loss/gain charged to the pool, the effect of which is automatically amortised by the Auto-Actuary in accordance with it's existing calculations procedure.
c. Preferably, System is also configured to monitor external data sources to search for indications that Member's membership should be invalidated, e.g. due to death. System may also have an outbound module which can use agents whether human or automated to contact members and check on their status periodically including their wellness and their availability. Such an outbound module of the system could also be used to contact next of kin or other nominated contacts of the member should System be unable to contact the member or obtain proof of life or should the member fail to validate their claim during a period and have their payouts suspended.

The outbound module could also be used to contact next of kin or nominated parties to initiate other processes including transfers of death benefits or inheritances or other actions if available.

Step 8. System further comprises an investment module configured to monitor the invest performance of the portfolio to calculate the return in the calculation period and update the expected return based upon, for example, the month rolling average return, the actual returns compared with the past expected returns, the variances, and so forth.

Step 9. System further comprises an actuarial model configured to look at the life expectancy of the remaining members of the pool, look at the actual life mortality of the pool versus the expected mortality, and plots the variance or mortality-drift, if any.

Step 10. System is then configured to calculate the payouts for the calculation period taking into account paying out the expected investment return and a portion of the capital less any ongoing costs or charges and run various risk models to calculate the optimal payout profiles that maintain the funds solvencies to the end of each tontine.

System is configured to run risk models such as but not limited to Monte Carlo analyses to plot the potential outcomes should the investment variance continue and/or should the mortality difference as well as future expected costs to refine the optimal payout series so as to ensure that the pool will remain always fully funded within acceptable bounds.

Step 11. Once System has determined the appropriate periodical payouts for the pool, System is configured to instruct its investment management module to liquidate sufficient assets from within the portfolio of each tontine fund to create the liquidity required to settle the upcoming payouts and fees of that tontine fund.

Step 12. System is then configured to calculate the payouts on an individual member basis by calculating the individual weights of each valid member's claim against the total valid member claims, and instruct its payment module to give effect to these payments thereby reducing the overall amount of assets of each tontine fund by the amount of the payments made to the members of each tontine fund and by any associated running costs. Payouts are then credited to the account of the members with all transactions being recorded on the ledger.

Step 13. Where a member of the pool has been confirmed to no longer have a valid membership of the pool, or in the absence of any ability to validate his/her membership of the pool, System is configured to either cancel the member's TMUs or re-allocate the TMUs in accordance with the relevant governing formulae of the pool and update the ledger accordingly.

Step 14. Where there is a differential for individual members or cohorts between the treatment for tax purposes of distributions of investment income, tax on unrealised gains, capital gains, and the return of original capital, the tax module of System may be configured to, by itself or at the request of the member, optimise the nature of the payout such that investment returns are capitalised on the ledger and payouts are given effect through means of a return of member's original capital through redeeming the originally allocated TMUs and/or a proportion of the TMUs awarded as capital gains and/or the TMUs which represent investment income in a given tax period for the member so as to alter the timing of the tax burden if any that may fall due on the periodic payments.

Step 15. Where members are part of a global portfolio for which they want to reduce currency or sector exposure from the investments or other risk factors, the System may further be configured to offer internal hedging between members of the pool that have opposite or balancing requirements or in an arrangement where other members of the pool accept such a hedging arrangement on the basis of a fee arrangement where the hedging costs of certain members are shared amongst other members as additional income.

Step 16. Where members of System are part of a global portfolio for which they want to reduce exposure to certain other members, System can be configured to offer internal hedging versus the other members of the pool such that the hedging costs of one member are shared amongst the other members as income on a pro-rata basis.

Step 17. Where members of System are part of a larger grouping for which they want to increase or reduce certain risk factors, System may be configured to automatically calculate the fair offset/hedging costs vis a vis the other members of the pool such that the offsetting costs or hedging costs of one member are shared amongst the other members as income on a pro-rata basis. Alternatively, members can offer to accept higher degrees of certain risks from other members in the pool, in return for compensation in the form of fees which can be negotiated or automatically calculated by System and automatically administered by System.

Many modifications and variations or different embodiments of the present invention are possible in view of the above disclosures, figures, drawings and explanations. Thus, it is to be understood that, within the scope of the appended claims, the invention can be practiced other than as specifically described above. The invention which is intended to be protected should not, however, be construed as limited to the particular forms disclosed, or implementation examples outlined, as these are to be regarded as illustrative rather than restrictive. Variations and changes could be made by those skilled in the art without deviating from the novelty of the invention. Accordingly, the foregoing detailed descriptions and figures should be considered exemplary in nature and not limited to the novelties of the invention as set forth in the claims.

1. A method for calculating, implementing and remotely communicating accurate payout projections in, or near, real-time with users of a peer-to-peer risk-sharing pension fund (Tontine System) comprising of servers connected to or adapted to access the internet, wireless devices adapted to access the internet, each server including an auto-actuary software module (AASM), each wireless device (WD) including a respective downloaded application software module (APP), and wherein;
(a) the WD is adapted to download a respective APP over the air, over the internet, and each WD automatically upon download of the respective APP into the WD, makes the APP operable to access WD functions and also makes the APP operable to communicate through the WD with the servers and the servers communicate with the WD and also to make the APP detect and be operable with, the hardware sensors or other biometric functionality of the WD and to transmit details of the functionality to the Tontine System to confirm that the WD meets the required minimum biometric recognition functionality of the AASM and wherein;
(b) each server is adapted to upload a respective AASM over the internet, and each server automatically upon upload of the respective AASM into a remote server, makes the AASM operable to access server functions and also makes the AASM operable to communicate through the server with the WDs and the WDs communicate with the servers and wherein;
(c) the AASM connects to external servers (ES) through the internet, these servers being different than the previous mentioned servers and wherein;
(d) the AASM fully autonomously interacts with the users of each WD, wherein the users APP receives notifications for the user to authenticate through providing data including the requested type of biometric information (e.g. facial recognition, eye recognition, hand palm scan, finger print scan, voice recognition) at regular time intervals (monthly, yearly)
(e) when the user accesses the APP, for example to respond to the notification, the AASM will validate that such data being provided belongs to the UserID being created and/or authenticated,
(f) at the same time the AASM interacts with a server or an ES capable of performing liveness detection upon the biometric information being transmitted to ensure that it is being generated in real time from the living user and thereby is neither an artificial biometric sample nor a legitimate biometric sample being used to authenticate access to system after the end of the User's life;
(g) once the user successfully authenticates their access to the Tontine System whilst passing the liveness detection challenge, the AASM creates and/or updates the status of the users Members account relating to the relevant UserID to record that, in the absence of any conflicting data to the contrary, proof of life has been confirmed and that the user is a living Member in the relevant period;
(h) the AASM updates the living Members account relating to the UserID to confirm that it is entitled to any upcoming relevant mortality credit (MC) related re-allocations of Tontine Member Units as well as any payouts in the period and transmits any new collected data including any updated facemap of the Member to the Tontine System to be appended to the ledgers in connection with the UserID;
(i) the AASM then calculates and re-allocates any Tontine Member Units available as a result of MCs from the accounts of Members who have not validated their Member accounts by passing the liveness detection challenge or otherwise providing proof of life in a format recognised by the AASM before the cut-off date for the relevant period of the same Tontine System fund or pool;
(j) the AASM then re-calculates in, or near, real-time the predicted payouts for the relevant Tontine System fund or pool using the latest data and Risk Factors and stores the updated forecasts on the ledgers from where the updated forecasts can be detected and downloaded to the APP when the WD next connects to the internet thus enabling the users to view the updated forecasts in or near real-time;
(k) at the end of any relevant period for each Tontine System fund or pool, the AASM communicates with and authorises and/or instructs its or the Tontine Systems payment module or a payment module on an ES to give initiate the relevant payout calculated by and predicted by the AASM for the period to each validated Member of that Tontine System fund or pool for the period and then updates the ledgers to record the payments made and to update the remaining predicted payout forecasts.

2. The system of claim 1 wherein, the WD functions accessed by the APP are:
(a) biometrical authentication scanning functions as camera access and/or
(b) finger print scanner access and/or
(c) microphone access and/or
(d) email contacts access and/or
(e) phone numbers contacts access
wherein the previously listed accessed information by the APP is send to the AASM and wherein,
(f) the AASM uses such biometrical and other information for any authentication interaction and as proof of life for the relevant period by interacting with a server or an ES capable of performing liveness detection upon the biometric information being transmitted to ensure that it is being generated in real time from the living user and thereby is neither an artificial biometric sample nor a legitimate biometric sample being used to authenticate access to system after the end of the User's life, and wherein
(g) the AASM stores any relevant collected data including any detected health data of the Member to its own ledgers in particular where such health or other data may be utilised in and potentially affect the ongoing Risk Factors calculations either for the Member individually or for the Tontine System as a whole, and wherein
(h) in the event of the user failing to successfully authenticate and pass the liveness detection test after a certain number of attempts in a defined period of elapsed time then the AASM may initiate a module within the AASM, the Tontine System or through an ES to utilise the emails, and phone numbers or other means of contact either for the user and/or their designated contacts to deliver notifications that for automated contact if no proof of life has been is obtained for the user and to offer alternative means of providing such required proof if in fact the user is still alive, or to initiate other processes including transfers of death benefits or inheritances where the user has passed away and/or wherein
(i) in the event of the AASM detecting a substantial variance in the health data or other data of the user as a result of analysing the biometric and liveness detection results and/or when compared to previously saved data including health data that the AASM may initiate a module within the AASM, the Tontine System or through an ES to utilise the emails, phone numbers or other means of contact either for the user and/or their designated contacts such as next of kin and/or to third parties such as, but not limited to, healthcare professionals, to deliver notifications that the user may be experiencing health issues and such notifications may include the transmission of data to request, suggest or initiate further actions.

3. The Tontine System of claim 1 of claim 2 wherein, the AASM accessed server functions are;
(a) server database and/or
(b) external servers (ES) different to the previous servers databases and/or
(c) notifications towards each corresponding user's APP and/or
(d) automated login request notifications to and periodic transmission of biometric authentication data from the APPs upon which data the AASM interacts with a server or ES capable of performing liveness detection verification before updating the biometric & health data records on the ledger to ensure that any due periodic payments or Tontine Fund Unit re-allocations are calculated and initiated only after the AASM has determined which users are alive or dead in any relevant period;
wherein the previously listed accessed information by the AASM from ES and the APPs and is stored and processed by the AASM in the server, which is also configured to connect to other ES to retrieve additional data including such information as;
(e) currencies exchange rates of the used currencies in the Tontine System fund, and/or
(f) ETF (exchange traded fund) exchange valuations of those ETFs used in the Tontine System fund, and/or
(g) Stock exchange valuations of those Stocks used in the Tontine System fund, and/or
(h) Bond exchange valuations of those Bonds used in the Tontine System fund, and/or
(i) Digital asset exchange valuations of those digital assets used in the Tontine System fund, and/or
(j) Longevity registers within the Tontine System or on ES containing values of those age and gender groups per region of the users in the Tontine System fund, and/or
(k) death registers listings of any regions relevant to the users in the Tontine System fund, and/or
(l) Other authoritative digital services whether private or civil which have the capability to certify as being dead or alive individual users in the Tontine System fund, and/or
(m) News feeds filtering on related words, figures or phrases that can metrically impact (i.e. medical breakthrough words with increased longevity expectation figures) the Tontine System fund solvency and/or payout
wherein the AASM uses such additional information (d) to including (m) from ES, for re-calculating the updated payout projections by means of processing the new data through one or a multitude of risk models including sensitivity analyses and simulations until the AASM is able to calculate a set of revised payout predictions that meet the rules of the pension scheme including for example that the new payout predictions of all of the members meets the criteria of solvency for the period until the last surviving user or until the last fixed payout date whichever comes first and wherein; (n) the AASM stores the updated data and forecasts on the server as well as the ledgers from where the updated forecasts can be detected and downloaded to the APPs when the WDs next connects to the internet thus enabling the users to view the updated forecasts in or near real-time; and wherein
(o) at the end of any relevant period for each Tontine System fund or pool, the AASM communicates with and authorises and/or instructs its or the Tontine Systems payment module or a payment module on an ES to initiate the most recent payouts calculated by and predicted by the AASM for the period to each validated Member of that Tontine System fund or pool for the period and then updates the ledgers to record the payments made and to update the remaining predicted payout forecasts.

4. The system of any preceding claim wherein, the AASM performs anti-fraud algorithms on all the Tontine System users interactions with the server to protect Tontine System fund's solvency and the compliance with applicable laws and regulation on money laundering and anti-terrorism financing, and wherein
(a) the AASM analyses the data provided by the user and upon any official credentials presented into the system by interfacing with authoritative ES and official databases and compares the biometric data included in the databases and/or the credentials against the biometric data which is the subject of the liveness detection challenge, and/or wherein
(b) the AASM monitors Meta Data from the accounts or virtual wallets and interactions with the Tontine Members, including but not limited to biometrical interactions, to detect or irregular or suspicious activities such as, but not limited to, a sudden change in spending habits inconsistent with the user profile, and wherein
(c) the AASM appends such data to ledgers utilises the results of the data processing to refine the risk score of User, such as but not limited to age, gender, ethnicity, socio-economic status, relationship status, health status, residential address, work address, or validity of identity numbers etc.

5. The system of claim 1 wherein Tontine System is formed as a plurality of two or more different Tontine Systems and/or including different embodiments of the peer-to-peer risk sharing pension scheme which are also known as collective defined contribution pension schemes (CDCs), with one AASM managing all Tontine Systems or each CDC has its own AASM and wherein
(a) all AASMs share all their data time-stamped such as to when any individual AASM detects variance in any risk factors (“RF”) then it may transmit the updated RF data to some or all of the other AASMs to be used by the other AASMs, Tontine Systems or CDCs, and wherein the other AASMs, Tontine Systems and/or CDCs will process and store the updated RF data and any resultant updated forecasts on these other servers as well as the ledgers from where the updated forecasts can be detected and downloaded to the APPs when the WDs next connects to the internet thus enabling the users to view the updated forecasts in or near real-time; and wherein
(b) at the end of any relevant period for each Tontine System fund or pool, the AASMs, Tontine Systems or CDCs may communicate with and authorise and/or instruct their own system payment module or a payment module on an ES to initiate the most recent payouts calculated by and predicted by the AASM, Tontine System or CDCs for the period to each validated Member of that Tontine System or CDC fund or pool for the period and then updates the ledgers to record the payments made and to update the remaining predicted payout

6. The system of claim 1 wherein the AASM manages one or multiple of the Tontine Systems fully autonomously and automatically without any human intervention nor human interaction required, except for only for the periodical interaction with the Tontine System users, and wherein
(a) the AASM calculates and implements updates to the forecasts being displayed in the APPs and the actual payouts being received by the Members to ensure that the Tontine Funds or Pools managed by the Tontine System stay in compliance with the rules of the Tontine Funds or Pools such as but not limited to ensuring that they remain solvent for the duration of the Tontine Funds or Pools and wherein in a further step
(b) the AASM fully autonomously and automatically without any human intervention nor interaction calculates and makes, through the internet, electronic payment transfers to its users on their account and/or makes electronic payment transfers to the Tontine System registered distribution partners or agents as payouts for new users subscribing through the AASM to the Tontine System fund.

7. The system of claim 1 wherein, the system for operating the Tontine System to make fully automated periodic payments to members of the Tontine System, wherein the periodic payments (fair periodic financial payments) to each member are paid out until the last survivor member's death or until another pre-defined condition or final cut-off date, whichever comes first, and wherein the system further comprising an AASM which enables a fully automated system to monitor, update and implement changes to the Tontine System risk parameters without any human intervention other than with the members wherein,
(a) each member registers to the “Tontine System” with at least one or more liveness detection enabled biometrical means of individual member identification, by interaction between the member and the AASM through the internet, resulting in the automated creation of a member account, and wherein
(b) each of the member transfers his financial contribution to the Tontine System by interaction between the member and the AASM through the internet, resulting in the automated update of the member account, and the update of the expected periodic payment financial amount, wherein
(c) the AASM fully autonomously creates a Tontine System fund and/or joins the member to an existing Tontine System fund, wherein
(d) the AASM periodically interconnects to data sources on ES outside of the Tontine System and updates the risk parameters and then recalculates the new expected periodic payment financial amounts and updates the scheduled payments in each Member's account as well as updating the forecasted payments on the server or ledger which will be used by the APP on the WD to display each Members future expected payouts, and wherein
(e) such data sources outside of the Tontine System are servers or any such other databases accessed by the AASM through the internet, and wherein
(f) the financial payments made by the system and the scheduled financial payments displayed in the APPs at any given time during the lifetime of the last surviving member or pre-defined final cut off whoever comes first, are determined by the new expected periodic payments amount calculated autonomously and automatically by the AASM, and wherein
(g) the AASM automatically corrects the change in value on expected longevity based upon the interaction of the AASM with data sources on ES outside of the Tontine System, and wherein
(h) the AASM recalculates the corresponding value change on the “new expected periodic payments amount” as a direct consequence and triggered by the change in value of expected longevity, repeating automatically calculation simulations until the AASM detects values that comply with the scheme rules of the Tontine System Fund for example but not limited to ensuring that the new values enable the continuing solvency of the Tontine System fund until for example but not limited to such conditions as the newly predicted last survivor member's expected length of lifetime or until a pre-defined final cut-off date, whichever comes first.

8. A Tontine System with an AASM is configured so as to deterministically implement in, or near real-time adjustments to the scheduled periodic payments being displayed and paid to members, wherein the periodic payments to each member are paid out until the last survivor member's lifetime or until a pre-defined final cut-off date, whichever comes first, the system comprising;
the AASM periodically interconnecting to external data sources outside of the Tontine System and updating the risk parameters and recalculating the expected periodic payment financial amount such that if such newly calculated expected periodic payment financial amount is different than the previous calculated expected periodic payment financial amount then the AASM automatically and autonomously replaces the previous by the newly calculated value, defined as “new expected periodic payments amount” and wherein,
such external data sources outside of the system are third party servers or any such other databases accessible by the AASM through the internet and wherein,
the external data accessed autonomously by the AASM are accessed through the internet from government databases, public database, private databases, be those free or membership based on credentials login, extracting the periodical and more recent data directly related to
(i) the Tontine System fund's composition value of its currencies values, individuals stocks, traded funds, digital assets or bonds or any such other public traded financial instrument, and
(ii) longevity data per region of the composition of the Tontine System members, and
(iii) official government death registers data per country/region of the composition of the Tontine System members and in a further step, and
(iv) authoritative digital services whether private or civil which have the capability to certify as being dead or alive individual users in the Tontine System fund and
(v) one or more global written and spoken news feeds data, and wherein;
the AASM fully autonomously acts as an artificial intelligence system auto learning following each obtained external data correlating with past events and using those actual past or current real-time changes including by determining the rate of variance of the risk factors in order to be able to predict & calculate future changes to the risk parameters used in the algorithms & method of FIG. which calculates and implements the “new expected periodic payments amount”.

9. The system of claim 8 wherein, the Tontine System with an AASM is configured so as to deterministically implement adjustments to the scheduled periodic payments being displayed and paid to members, wherein the periodic payments to each member are paid out until the last survivor member's lifetime or until a pre-defined final cut-off date, whichever comes first, the system comprising;
the AASM periodically interconnecting to external data sources outside of the Tontine System and updating the risk parameters and recalculating the expected periodic payment financial amount such that if such newly calculated expected periodic payment financial amount is different than the previous calculated expected periodic payment financial amount then the AASM automatically and autonomously replaces the previous by the newly calculated value, defined as “new expected periodic payments amount” and wherein,
such external data sources outside of the system are third party servers or any such other databases accessible by the AASM through the internet and wherein,
the external data accessed autonomously by the AASM are accessed through the internet from government databases, public database, private databases, be those free or membership based on credentials login, extracting the periodical and more recent data directly related to
(i) the Tontine System fund's composition value of its currencies values, individuals stocks, traded funds or bunds or any such other public traded financial instrument, and
(ii) longevity data per region of the composition of the Tontine System members, and
(iii) official government death registers data per country/region of the composition of the Tontine System members and
(iv) Other authoritative digital services whether private or civil which have the capability to certify as being dead or alive individual users in the Tontine System fund and in a further step, and
(v) one or more global written and spoken news feeds data, and wherein;
the AASM's fully autonomously acts as an artificial intelligence system auto learning following each obtained external data correlating with past events and using those actual past or current real-time changes to extrapolate future changes on the risk parameters used to calculate the members' death predictions and the “new expected periodic payments amount”, such past correlation on the impact in example of actual death certification of a member extracted autonomously by the AASM from a governmental death registry server to correlate it to a new future member death certification a governmental death registry server auto-detected and automatically correcting the increase on expected death rate per age group of the remaining members by the AASM instantly redistributing the entitlements of the deceased members (users) pro-rata to the risk parameters as a fair value amongst the surviving members and recalculating the corresponding value increase on “new expected periodic payments amount” by repetitive simulation calculations until the new value ensures solvency of the Tontine System fund until the new predicted last survivor member's lifetime date or until a pre-defined final cut-off date, whichever comes first.

10. A method of operating a Tontine System, the system comprising servers including an AASM, WDs including an APP, and wherein the method including the steps of;
(a) the WD downloading an application software module APP over the air, over the internet, and each WD automatically upon download of the respective APP into the WD, making the APP operable to access WD functions and also making the APP operable to communicate through the WD with the servers and the servers communicate with the WD and wherein;
(b) the server uploading an AASM over the internet, and each server automatically upon uploading of the AASM into the remote server, making the AASM operable to access server functions and also making the AASM operable to communicate through the server with the WDs and the WDs communicate with the servers and wherein in a further step;
(c) the AASM fully autonomously interacts with the users of each WD, wherein the user authenticates through biometrical means at regular time intervals (monthly, yearly) as proof of life and/or prior to any payout of the Tontine System to the user and wherein,
(d) the AASM fully autonomously, without any human intervention nor interaction, connects to external servers (ES) through the internet, these servers being different than the previous mentioned servers.

11. The method of claim 10 wherein, the WD functions accessed by the APP are
(a) biometrical authentication scanning functions as camera access, and/or
(b) finger print scanner access, and/or
(c) microphone access, and/or
(d) email contacts access, and/or
(e) phone numbers contacts access
and wherein in a further step the previously listed accessed information by the APP is sent to the AASM and wherein,
(f) the AASM uses such biometrical and other information for any authentication interaction authentication and as proof of life for the relevant period by interacting with a server or an ES capable of performing liveness detection upon the biometric information being transmitted to ensure that it is being generated in real time from the living user and thereby is neither an artificial biometric sample nor a legitimate biometric sample being used to authenticate access to system after the end of the User's life, and wherein
(g) the AASM stores any relevant collected data including any detected health data of the Member to its own ledgers in particular where such health or other data may be utilised in and potentially affect the ongoing Risk Factors calculations either for the Member individually or for the Tontine System as a whole, and wherein
(h) in the event of the user failing to successfully authenticate and pass the liveness detection test after a certain number of attempts in a defined period of elapsed time then the AASM may initiate a module within the AASM, the Tontine System or through an ES to utilise the emails, and phone numbers or other means of contact either for the user and/or their designated contacts to deliver notifications that for automated contact if no proof of life has been is obtained for the user and to offer alternative means of providing such required proof if in fact the user is still alive, or to initiate other processes including transfers of death benefits or inheritances where the user has passed away and/or wherein
(i) in the event of the AASM detecting a substantial variance in the health data or other data of the user as a result of analysing the biometric and liveness detection results and/or when compared to previously saved data including health data that the AASM may initiate a module within the AASM, the Tontine System or through an ES to utilise the emails, phone numbers or other means of contact either for the user and/or their designated contacts such as next of kin and/or to third parties such as, but not limited to, healthcare professionals, to deliver notifications that the user may be experiencing health issues and such notifications may include the transmission of data to request, suggest or initiate further actions.

12. The method of claim 10 wherein, the AASM accessed server functions are;
(a) server database, and/or
(b) external servers (ES) different to the previous servers databases, and/or
(c) notifications towards each corresponding user's APP, and/or
(d) automated login request notifications to and periodic transmission of biometric authentication data from the APPs upon which data the AASM interacts with a server or ES capable of performing liveness detection verification before updating the biometric & health data records on the ledger to ensure that any due periodic payments or Tontine Fund Unit re-allocations are calculated and initiated only after the AASM has determined which users are alive or dead in any relevant period, wherein in a further step the previously listed accessed information by the AASM from the ES and the APPs and is stored and processed by the AASM in the server, which is also configured to connect to other ES to retrieve additional data including such information being,
(e) currencies exchange rates of the used currencies in the Tontine System fund, and/or
(f) ETF (exchange traded fund) exchange valuations of those ETFs used in the Tontine System fund, and/or
(g) Stock exchange valuations of those Stocks used in the Tontine System fund, and/or
(h) Bond exchange valuations of those Bonds used in the Tontine System fund, and/or
(i) Digital exchange valuations of those Digital Assets used in the Tontine System fund, and/or
(j) Longevity registers containing values of those age and gender groups per region of the users in the Tontine System fund, and/or
(k) death registers listings of those individual user's regions of the users in the Tontine System fund, and/or
(l) Other authoritative digital services whether private or civil which have the capability to certify as being dead or alive individual users in the Tontine System fund, and/or
(m) News feeds filtering on related words, figures or phrases that can metrically impact (i.e. medical breakthrough words with increased longevity expectation figures) the Tontine System fund solvency, and/or payout
wherein in a further step the AASM uses such information (d) to including (m) from ES, for re-calculating the updated new payout projections by means of processing the new data through one or a multitude of risk models including sensitivity analyses value in and consecutive simulations until the AASM is able to calculate a set of revised payout predictions that meet the rules of the pension scheme including for example that the new payout predictions of all of the members it meets the criteria of solvency for the period until the last surviving user or until the last fixed payout date whichever comes first, and wherein
(n) the AASM stores the updated data and forecasts on the server as well as the ledgers from where the updated forecasts can be detected and downloaded to the APPs when the WDs next connects to the internet thus enabling the users to view the updated forecasts in or near real-time, and wherein
(o) at the end of any relevant period for each Tontine System fund or pool, the AASM communicates with and authorises and/or instructs its or the Tontine Systems payment module or a payment module on an ES to initiate the most recent payouts calculated by and predicted by the AASM for the period to each validated Member of that Tontine System fund or pool for the period and then updates the ledgers to record the payments made and to update the remaining predicted payout forecasts.

13. The method of claim 10 wherein, the AASM performs anti-fraud algorithms on all the Tontine System users' interactions with the server to protect Tontine System fund's solvency and the compliance with applicable laws and regulation on money laundering and anti-terrorism financing, and wherein
(a) the AASM analyses the data provided by the user and upon any official credentials presented into the system by interfacing with authoritative ES and official databases and compares the biometric data included in the databases and/or the credentials against the biometric data which is the subject of the liveness detection challenge, and/or wherein
(b) the AASM monitors Meta Data from the accounts or virtual wallets and interactions with the Tontine Members, including but not limited to biometrical interactions, to detect or irregular or suspicious activities such as, but not limited to, a sudden change in spending habits inconsistent with the user profile, and wherein
(c) the AASM appends such data to ledgers utilises the results of the data processing to refine the risk score of User, such as but not limited to age, gender, ethnicity, socio-economic status, relationship status, health status, residential address, work address, or validity of identity numbers etc.

14. The method of claim 10 wherein the Tontine System is formed as a plurality of two or more Tontine Systems and/or including different embodiments of the peer-to-peer risk sharing pension scheme which are also known as collective defined contribution pension schemes (CDCs), with one AASM managing all Tontine Systems or each CDC has its own AASM and wherein
(a) all AASMs share all their data time-stamped such as to when any individual AASM detects variance in any risk factors (“RF”) then it may transmit the updated RF data to some or all of the other AASMs to be used by the other AASMs, Tontine Systems or CDCs, and wherein
the other AASMs, Tontine Systems and/or CDCs will process and store the updated RF data and any resultant updated forecasts on these other servers as well as the ledgers from where the updated forecasts can be detected and downloaded to the APPs when the WDs next connects to the internet thus enabling the users to view the updated forecasts in or near real-time; and wherein
(b) at the end of any relevant period for each Tontine System fund or pool, the AASMs, Tontine Systems or CDCs may communicate with and authorise and/or instruct their own system payment module or a payment module on an ES to initiate the most recent payouts calculated by and predicted by the AASM, Tontine System or CDCs for the period to each validated Member of that Tontine System or CDC fund or pool for the period and then updates the ledgers to record the payments made and to update the remaining predicted payouts.

15. The method of claim 10 wherein the AASM in a further step manages one or multiple of the Tontine Systems and/or CDCs fully autonomously and automatically without any human intervention nor interaction required, safe only for the periodical interaction with the Tontine Systems users.

16. The method of claim 10 wherein the AASM in a further step manages one or multiple of the Tontine System fully autonomously and automatically without any human intervention nor interaction required, except only for the periodical interaction with the Tontine System users, and wherein
(a) the AASM calculates and implements updates to the forecasts being displayed in the APPs and the actual payouts being received by the Members to ensure that the Tontine Funds or Pools managed by the Tontine System stay in compliance with the rules of the Tontine Funds or Pools such as but not limited to ensuring that they remain solvent for the duration of the Tontine Funds or Pools and wherein in a further step
(b) the AASM fully autonomously and automatically without any human intervention nor interaction calculates and makes, through the internet, electronic payment transfers to its users on their account and/or makes electronic payment transfers to the Tontine System registered distribution partners or agents as payouts for new users subscribing through the AASM to the Tontine System fund.
